(19) United States
(12) Patent Application Publication
(10) Pub. No.: US 2004/0127084 A1
(43) Pub. Date: Jul. 1, 2004

(54) Connector

(76) Inventors: Allan Glennie, Aberdeenshire (GB); Murray McIntosh, Aberdeenshire (GB)

Correspondence Address: Gregory J Lavorgna, Drinker Biddle & Reath, One Logan Square, 18th & Cherry Streets, Philadelphia, PA, 19103-6996, US

(21) Appl. No.: 10/477,088

(22) PCT Filed: May 17, 2002
(86) PCT No.: PCT/GB02/02335

(30) Foreign Application Priority Data
May 17, 2001 (GB) 0112049.2

(51) Int. Cl. H01R 13/213

(52) U.S. Cl. 439/316

(57) ABSTRACT

A connector, typically used for connecting cables or other conduits under water. The connector has a first portion (5) which has a bayonet (15) and a second portion (25), which receives the bayonet (15). The bayonet (15) rotates in order to align the head of the bayonet (15) with a receptacle (35) in the other portion, and to jam the head of the bayonet into the receptacle in certain configurations, so that the two connector portions (5, 25) are locked together. Means are optionally provided to release the bayonet (15) from the receptacle (35) if the screw threads jam.

This invention relates to a connector.

Subsea connectors are well known for connecting a manifold to a flow line or a group of lines. Conventional connectors generally involve some kind of threaded connection between first and second portions. The threaded connection is tightened in order to draw the two portions together, and to connect the lines. It is well established that engaging the threaded connection only when the first and second portions are initially mated together is undesirable, because the threads are liable to be incorrectly aligned, leading to damage of the threads, and also because debris can enter the threads and prevent their action. For this reason, some conventional connectors have employed a bayonet fitting to make up the initial connection. In such connectors, a bayonet on one of the portions is engaged within the receptacle on the other portion, and turned in order to misalign the radial protrusions on the bayonet with the entrance to the receptacle, thereby lodging the bayonet in the receptacle.

According to the present invention there is provided a connector having a first portion and a second portion, one of which has a bayonet that engages in a receptacle on the other, the connector having a guide mechanism for turning the bayonet within the receptacle.

Limiting or otherwise controlling the amount, extent and timing of the turning of the bayonet reduces the risk of accidental disconnection.

Typically the guide mechanism is disposed on the same portion of the connector that carries the bayonet.

Typically the guide mechanism comprises a pin constrained to move with a slot or groove. Typically the pin is provided on the bayonet, and a slot is provided on a sleeve that surrounds the bayonet. However, these can be reversed, with the slot being provided on the bayonet, and the pin on the sleeve or housing through which the bayonet travels.

Typically the connector has a screw thread mechanism for drawing the two portions of the connector together, typically after engagement of the bayonet within the receptacle. Typically the bayonet is provided on the first portion, and the receptacle is provided on the second portion. Typically the first portion comprises a male portion that is adapted to be received within the second female portion.

Typically each of the portions to be connected carries one or more fluid conducting lines that are sealingly connected to corresponding fluid conducting lines on the other portion.

Typically the bayonet fixing is mounted on a shaft, and the shaft can preferably be provided with a thread on its outer surface. In preferred embodiments, the shaft of the bayonet is received within a socket on the first portion, and the socket is typically threaded on its inner surface with a thread that co-operates with the thread on the outer surface of the shaft of the bayonet. The action of the co-operating threads between the shaft and socket moves the shaft of the bayonet axially with respect to the socket. The socket is typically axially fixed to the first portion of the connector, so that the action of the co-operating threads moves the shaft of the bayonet axially with respect to the whole of the first part of the connector.

An embodiment of the present invention will now be described by way of example and with reference to the accompanying drawings, in which:

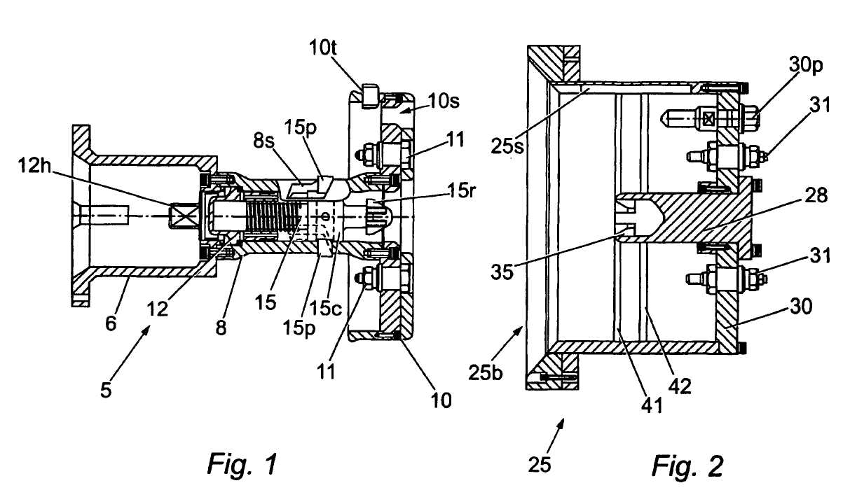

FIG. 1 is a side sectional view through a first male portion of the connector;

FIG. 2 is a side sectional view through a second female portion of the connector;

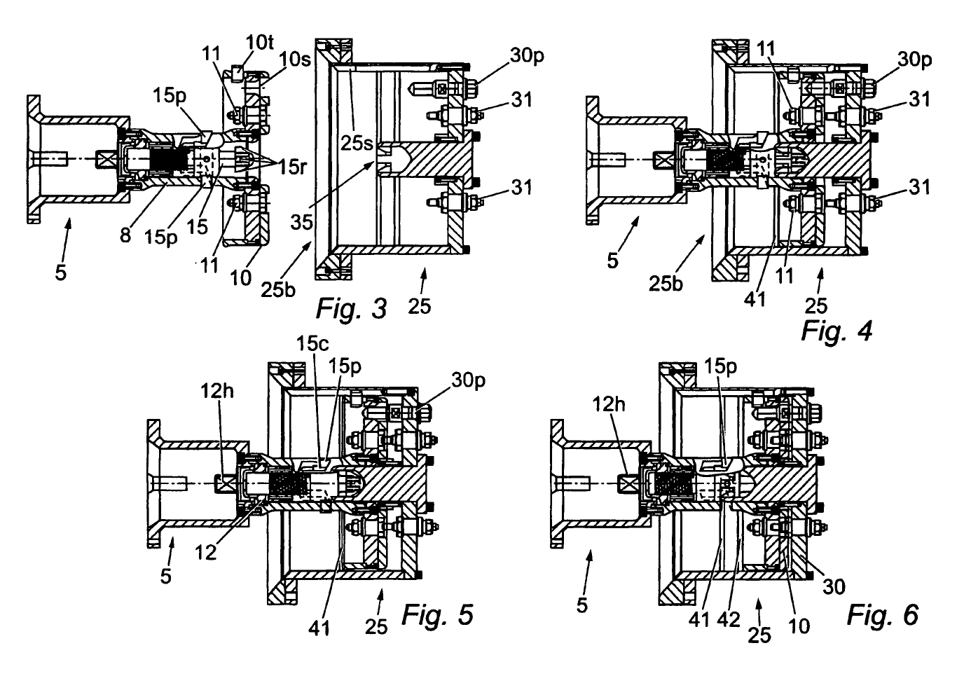

FIGS. 3-6 are similar views of the male and female connectors showing the sequence of mating;

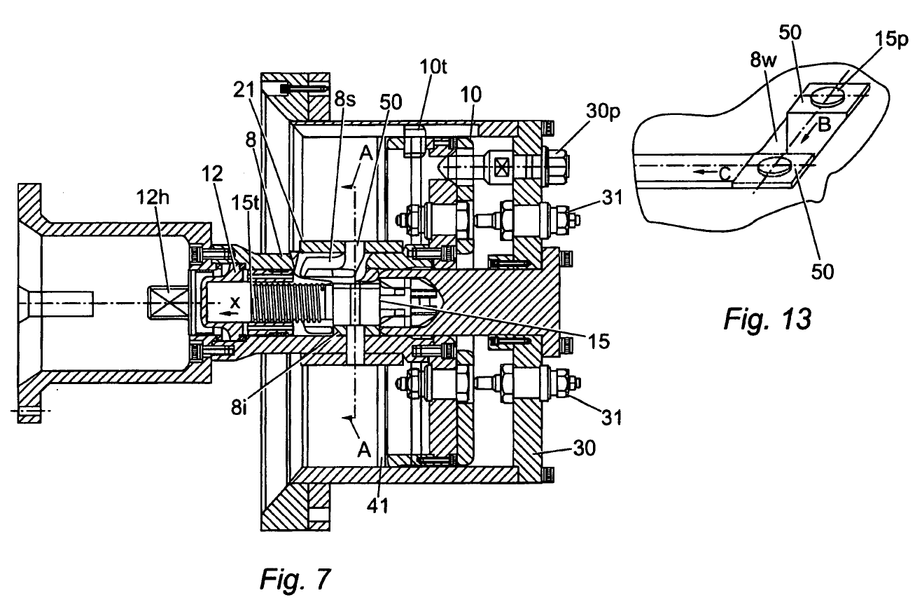

FIG. 7 is a side sectional view of an alternative embodiment in an alignment position;

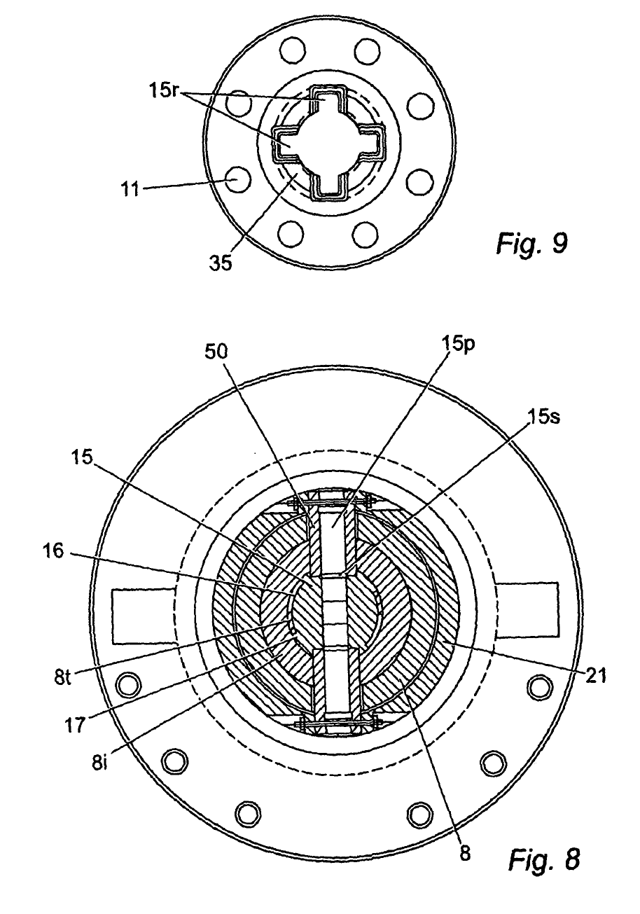

FIG. 8 is a partial cross-section along the “A-A” of FIG. 7;

FIG. 9 is an end view of a bayonet head and a receptacle corresponding to FIG. 7;

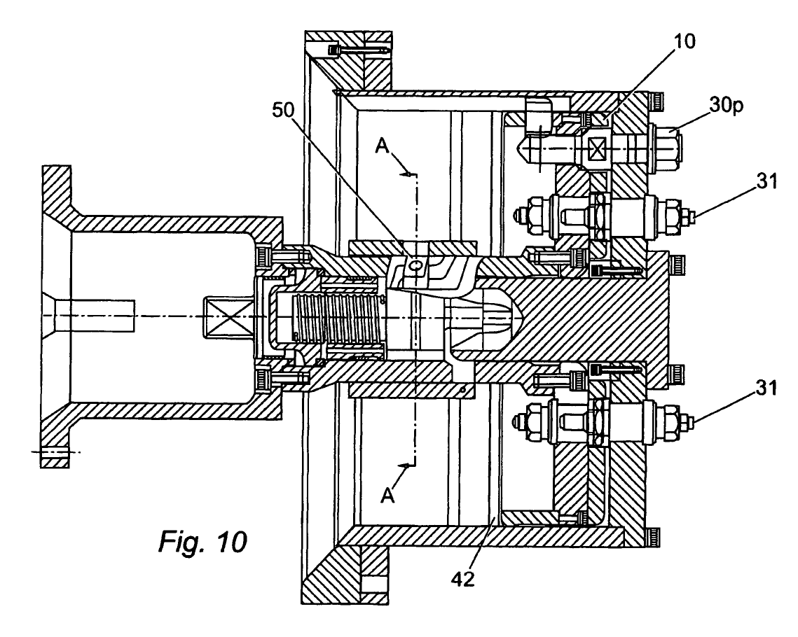

FIG. 10 is an a side sectional view of the embodiment of FIG. 7 in a fully mated position;

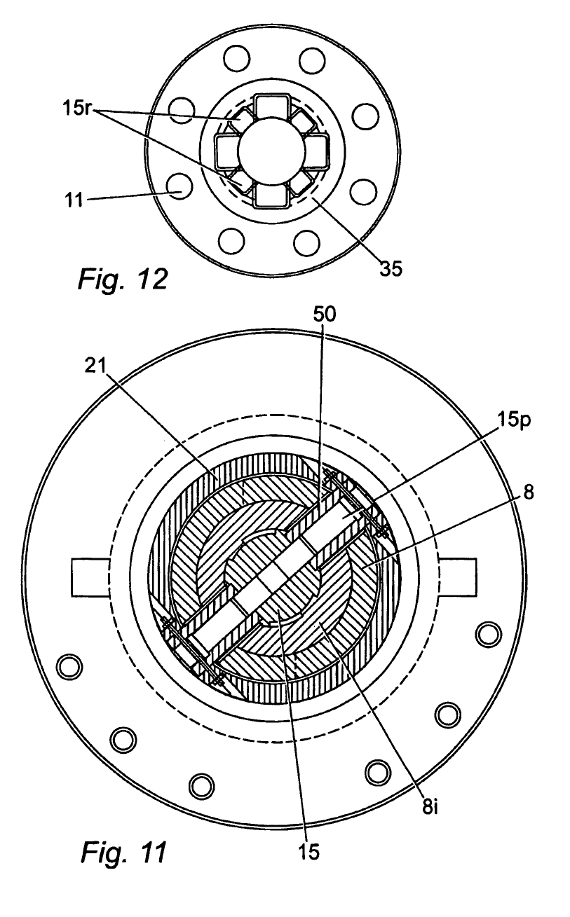

FIG. 11 is a partial cross-section along the “A-A” of FIG. 10;

FIG. 12 is an end view of a bayonet head and a receptacle corresponding to FIG. 10;

FIG. 13 is a perspective view of a dogleg slot.

Referring now to the drawings, a first male portion 5 of the connector has a hollow body 6 connected to one end of a bayonet sleeve 8, the other end of which is connected to a stab plate 10 having fluid connectors 11. A central aperture on the plate 10 is axially aligned with a bayonet shaft 15, which is housed within the bayonet sleeve 8. The bayonet sleeve 8 has a pair of dogleg slots 8s, and houses a socket 12 that is sealed to the bayonet sleeve 8. The socket 12 has a threaded inner bore to receive the shaft of the bayonet 15. The shaft of the bayonet 15 is threaded on its outer surface, and the threads on the shaft of the bayonet 15 and the inner bore of the socket 12 co-operate so that rotation of the socket 12 relative to the shaft 15 results in relative axial movement of the two components.

The head of the bayonet shaft 15 has four radial protrusions 15r.

The socket 12 has a flange that is axially restrained within the bayonet sleeve 8, preventing the socket 12 from axial movement relative to the bayonet sleeve 8, and therefore from axial movement relative to the male part 5 of the connector, to which the bayonet sleeve 8 is attached. However, the socket 12 is free to rotate around the axis of its bore, relative to the rest of the male part 5. The socket 12 is rotationally connected to a hex head 12h that extends from the bayonet sleeve 8 into the hollow bore of the body 6. Torque applied to the hex head 12h turns the socket 12 within the bayonet sleeve 8.

The bayonet shaft 15 has a collar 15c that can either be an integral part of the bayonet shaft 15, or can be connected e.g. by screws onto the bayonet shaft 15, as is the case in this embodiment. The collar 15c has a pair of diagonally opposed pins 15p which extend radially outward from the axis of the shaft of the bayonet 15 and are received within the dog leg slots 8s of the bayonet sleeve 8.

The pins 15p are free to move within the dogleg slots 8s, which are likewise spaced 180 degrees around the circumference of the bayonet sleeve 8. Each of the dog leg slots 8s has a first axial portion that extends generally parallel to the axis of the bayonet shaft 15, and a second dog leg portion that extends around the circumference of the bayonet sleeve 8s at an oblique angle to the axis of the bayonet shaft 15. The opposite ends of each dog leg slot are circumferentially spaced at precisely 45 degrees around the circumference of the bayonet sleeve 8s, and are also, of course, axially spaced parallel to the axis of the bayonet shaft 15. Since the starting and finishing points of each dog leg slot 8s are precisely defined with respect to each other, and since the pins 15p are fastened to the bayonet shaft 15, the range of movement of the bayonet shaft 15 within the first portion 5 when the socket 12 is rotated is strictly governed by the constraints of movement of the pins 15p within the slots 8s.

Turning now to FIG. 2, a second female portion 25 has a hollow bore 25b to receive the first male portion 5, with a guide slot 25s to receive a tab 10t on the plate of the male portion 5, so as to align the male and female portions in the correct orientation. First and second indicator grooves 41, 42 are disposed on the inside surface of the bore 25b. The indicator grooves 41, 42 are annular and axially spaced apart; they are preferably brightly coloured so that they are easily visible to an ROV pilot. The female portion 25 has an end plate 30 with fluid connectors 31 to co-operate with the fluid connectors 11 on the plate 10 of the male portion 5. The fluid connectors 31 and 11 are respectively connected at their opposite ends to fluid lines to be connected in the made up connector.

The female portion 25 has an axial mounting 28 in which is provided a receptacle 35 to receive the head of the bayonet shaft 15 on the male portion 5. The axial mounting 28 is axially aligned with the bayonet shaft 15 in the made up connector. The receptacle 35 has inwardly protruding formations defining between them an opening to the receptacle which is generally cross shaped in end view.

Referring now to FIGS. 3-6, the male portion 5 is offered to the bore 25b of the female portion 25 so that the plate 10 starts to enter the bore 25b. The male portion 5 is rotated axially so that the tab 10t is aligned with the slot 25s, at which point the male part 5 can advance into the bore 25b as shown in the sequence of FIGS. 3 and 4. In that orientation, the fluid connectors 31 and 11 are aligned for connection of the respective fluid lines. It is important that the bayonet shaft 15 is advanced to its furthest extent within the bayonet sleeve 8, with the pins 15p forced against the ends of the second dog leg portions of the slots 8s, as in this position, the bayonet shaft 15 is extended to its furthest reach in the bayonet sleeve 8, and the radial protrusions 15r on the head of the bayonet shaft 15 are aligned at “12, 3, 6, and 9 o'clock” positions that match the cross shaped opening of the receptacle 35. Therefore, the head of the bayonet shaft 15 can enter the receptacle 35, allowing alignment pin 30p to engage in a guide socket 10s on the plate 10 of the first male portion 5. At this point, the connector parts are aligned but not yet made up in the position shown in FIG. 4. The ROV pilot knows that the head of the bayonet shaft 15 is engaged in the receptacle 35 when the first indicator groove 41 just becomes visible from behind the stab plate 10 of the male portion 5.

At that point, the hex head 12h is turned thereby turning the socket 12 and by means of the co-operation between the threads, thereby pulling the collar 15c towards the first male portion 5 as shown in FIG. 5. As the collar 15c is drawn by the threads axially towards the male portion 5, the pins 15p are constrained to move along the oblique second portion of the slot 8s towards the position shown in FIG. 5. Once the pins 15p have travelled from the distal ends of the second oblique portions of the slots 8s to the bend in the slot 8s, the collar, and therefore the bayonet shaft 15 to which it is attached, is turned through exactly 45 degrees. This turns the head of the bayonet shaft 15 through 45 degrees as shown in FIG. 5, at which point, the radial protrusions 15r are moved out of alignment with the cross shaped opening to the receptacle 35, and the head of the bayonet shaft 15 is thereby trapped within the receptacle 35.

Further rotation of the hex head 12h draws the shaft of the bayonet 15 towards the male portion 5 until the pins 15p meet the proximal ends of the dog leg slots 8s nearest to the male portion 5, and can travel no more. Since the pins 15p are circumferentially restrained by the axial first part of the slots 8s, they cannot rotate around the axis of the bayonet shaft 15, and thus the head of the bayonet shaft 15 (to which the pins 15p are attached) cannot rotate and pull out of the receptacle 35. Therefore, the risk of disengaging the two portions of the connector 5,25 is reduced.

When the shaft of the bayonet 15 has been drawn fully towards the male portion 5, and the pins 15p have travelled the full length of the slots 8s, the two plates 10, 30 are fully drawn together, and the fluid connections 11, 31 between the respective fluid lines are fully made up, as shown in FIG. 6. The ROV pilot knows that the connector is fully made up when the second indicator groove 42 becomes visible from behind the stab plate 10 of the male portion 5.

In order to disengage the two parts of the connector, the hex head 12h is simply turned in the opposite direction, driving the pins 15p back along the slots 8s to the opposite end of the dog leg at which point the rotation of the collar 15c has realigned the radial protrusions 15r on the head of the bayonet shaft 15 with the cross shaped opening of the receptacle 35, allowing the bayonet head to be withdrawn from the receptacle 35, and the connection to be broken.

An alternative embodiment is shown in FIGS. 7 to 12. As best shown in FIG. 8, the pins 15p are shear pins and have a shear section 15s. This section 15s is weaker than the rest of the pin 15p and will break if too much pressure bears upon it.

Each pin 15p is disposed inside a respective bush 50.

The bayonet shaft 15 has two cutaways 16 on its circumference, which are recesses in the outer surface of the bayonet shaft 15. The cutaways 16 have abrupt ends, which define a step 17, and are spaced approximately 180 degrees apart from each other.

The male portion 5 has an inner sleeve 8i disposed between the sleeve 8 and the bayonet 15. The inner sleeve 8i has two holes through which the pins 15p (in their bushes 50) extend. The inner sleeve 8i has teeth 8t, which extend radially inwards from the inner sleeve 8i and into the cutaways 16. Thus, the cutaways 16 define the range of angular movement of the shaft 15 with respect to the inner sleeve 8i. The inner sleeve 8i is rotatable relative to the sleeve 8 and is also rotatable relative to the bayonet 15.

As in the first embodiment, each pin 15p moves in a respective dogleg slot 8s in the sleeve 8. The dogleg slots 8s each have two portions: a first axial portion, and a second portion that extends around the circumference of the bayonet sleeve 8s at an oblique angle to the axis of the bayonet shaft 15. The angle of inclination is preferably about 75 degrees.

The slots 8s are not necessarily dogleg shaped; they could be L-shaped.

A protective shroud 21 is disposed on the exterior surface of the sleeve 8, and is rotatable relative to the sleeve 8. The protective shroud 21 has two interior cup-shaped recesses. Each pin 15p extends through its doglet slot and engages with a respective recess in the shroud 21. The shroud 21 will thus rotate with the bayonet 15. The shroud 21 can also prevent the pins 15p from falling out of their bushes 50 after shearing.

The exterior surface of the sleeve 8 optionally has indicator markings, which, by comparison with a further marking on the exterior surface of the shroud 21, can indicate both the relative rotation and axial position of the shroud 21 (and thus the bayonet 15) with respect to the sleeve 8.

Other features of the embodiment are the same as those described in the first embodiment and have the same reference numerals.

In use, the male portion 5 is offered to the bore 25b of the female portion 25 so that the plate 10 starts to enter the bore 25b. The male portion 5 is rotated axially so that the tab 10t is aligned with the slot 25s, at which point the male portion 5 can advance into the bore 25b. In that orientation, the fluid connectors 31 and 11 are aligned for connection of the respective fluid lines. It is important that the bayonet shaft 15 is advanced to its furthest extent within the bayonet sleeve 8, with the pins 15p forced against the ends of the second dog leg portions of the slots 8s, as in this position, the bayonet shaft 15 is extended to its furthest reach in the bayonet sleeve 8, and the radial protrusions 15r on the head of the bayonet shaft 15 are aligned at “12, 3, 6, and 9 o'clock” positions shown in FIG. 9 that match the cross shaped opening of the receptacle 35. Therefore, the head of the bayonet shaft 15 can enter the receptacle 35, allowing alignment pin 30p to engage in a guide socket 10s on the plate 10 of the first male portion 5. At this point, the connector portions 5,25 are aligned but not yet made up in the position shown in FIG. 7. As in the first embodiment, the correct axial positioning of the connector portions is confirmed to the ROV pilot by the appearance of the first indicator groove 41 from behind the stab plate 10.

The bush 50 is at its maximum anti-clockwise position in the dogleg slot 8s, as shown in FIG. 13.

At that point, the hex head 12h is rotated clockwise as viewed from the male portion 5 looking towards the female portion 25, thereby turning the socket 12. The socket 12 freely rotates relative to the sleeve 8 and by means of the co-operation between the threads, pulls the collar 15c towards the first portion 5 as shown by the arrow X in FIG. 7.

The movement of the collar 15c pulls the bush 50 against the wall of the dogleg slot 8w. The wall 8w prevents any further movement of the bayonet shaft in the direction of arrow X.

Further movement of the hex head 12h now also turns the bayonet shaft 15. This causes the step 17 of the bayonet shaft 15 to engage the tooth 8t of the inner sleeve 8i, as shown in FIG. 8.

The inner sleeve 8i pushes the bush 50 and the pin 15p clockwise in the dogleg slot 8, as shown by the arrow B in FIG. 13. The inclination of this part of the dogleg slot 8s relative to the axis of the bayonet 15 means that as the bayonet rotates, the bayonet 15 also moves axially relative to the socket 12 which pulls the male portion 5 and the female portion 25 closer together. This initiates the mating process.

Once the pins 15p have travelled from the distal ends of the second oblique portions of the slots Bs to the bend in the slot 8s, the collar 15c, and therefore the bayonet shaft 15 to which it is attached, is turned through exactly 45 degrees.

This turns the head of the bayonet shaft 15 through 45 degrees to the position shown in FIG. 12, at which point, the radial protrusions 15r are moved out of alignment with the cross shaped opening to the receptacle 35, and the head of the bayonet shaft 15 is thereby trapped within the receptacle 35. The ROV pilot can check that the bayonet 15 has rotated through 45 degrees (and thus that the pins 15p have moved correctly along the second oblique portions of the slots 8s) by comparing the circumferential position of the marking on the exterior of the shroud 21 with the indicator markings on the sleeve 8.

As the bush is now in line with the axial part of the dogleg slot 8, the shaft of the bayonet 15 cannot rotate any further clockwise. But, since axial movement of the bayonet 15 is possible, the bayonet shaft 15 moves relative to the socket 12 by means of the co-operating threads.

Thus, further rotation of the hex head 12h draws the shaft of the bayonet 15 towards the male portion 5 until the pins 15p meet the proximal end of the dog leg slots 8s nearest to the male portion 5, and can travel no more. The pins 15p move axially in the dogleg slots 8s, and thus the shroud 21 moves axially relative to the sleeve 8. The ROV pilot can check that the pins 15p have moved through the axial portion of the slots 8s by comparing the position of the end of the shroud 21 with the indicator markings on the sleeve 8.

Since the pins 15p are circumferentially restrained by the axial first part of the slot, they cannot rotate around the axis of the bayonet shaft 15, and thus the head of the bayonet shaft 15 (to which the pins 15p are attached) cannot rotate and pull out of the receptacle 35. Therefore, the risk of disengaging the two portions of the connector 5,25 is reduced.

When the shaft of the bayonet 15 has been drawn fully towards the male portion 5, and the pins 15p have travelled the full length of the slots 8s, the two plates 10, 30 are fully drawn together, and the fluid connections 11, 31 between the respective fluid lines are fully made up, as shown in FIG. 10. This fully mated position is confirmed to the ROV pilot by the appearance of the indicator groove 42 from behind the stab plate 10.

In order to disengage the two parts of the connector, the hex head 12h is simply turned in the opposite direction, driving the pins 15p back along the slots 8s to the opposite end of the dogleg, at which point the rotation of the collar 15c has realigned the radial protrusions 15r on the head of the bayonet shaft 15 with the cross shaped opening of the receptacle 35, allowing the bayonet head to be withdrawn from the receptacle 35, and the connection to be broken.

If the co-operating threads jam and the bayonet 15 becomes stuck in the socket 12, the hex head can be rotated anti-clockwise forcefully to free the bayonet shaft 15 from the receptacle 35.

In this case, rotation of the hex head rotates the socket 12 and the bayonet shaft 15 together relative to the sleeve 8. The teeth 8t move in the cutaways 17, and so the shaft pushes the part of the pin 15p below the shear section 15s in an anti-clockwise direction, whilst the part of the pin 15p above the shear section 15s is held stationary by the sleeve 8. This applies a shear force to the pin 15p, which, if it is large enough, will shear the pin 15p.

Now the bayonet shaft 15 (still fixed relative to the socket 12) can be freely rotated to align the radial protrusions on the bayonet 15 with the opening to the receptacle 35 to free the bayonet shaft 15 from the receptacle 35. On recovery to the surface, the shear pins 15p can be replaced to restore the connector to full working order.

It should be noted that (as shown in FIG. 8) the relative positions of the step 17 and the tooth 8t are such that the tooth 8t bears against the step 17 in the alignment position. This means that any clockwise rotation of the bayonet 15 will always move the inner sleeve 8i as well. The inner sleeve 8i pushes on the bush 50, instead of directly on the shear pin 15p. This means that however hard the hex head 12h is turned clockwise, the shear pin 15p will not break. This avoids the failure of the shear pin 15p during the connection phase. The shear pin 15p can only be broken when the bayonet shaft 15 is turned anti-clockwise, i.e. in the disconnection phase.

Modifications and improvements can be incorporated without departing from the scope of the invention.

1. A connector having a first portion and a second portion, one of which has a bayonet that engages in a receptacle on the other, the connector having a guide mechanism for turning the bayonet within the receptacle.

2. A connector as claimed in claim 1, wherein the guide mechanism is disposed on the same portion of the connector that carries the bayonet.

3. A connector as claimed in claim 1 or claim 2, wherein the guide mechanism comprises a pin constrained to move with a slot or groove.

4. A connector as claimed in claim 3, wherein the pin is provided on the bayonet, and the slot or groove is provided on a sleeve that surrounds the bayonet.

5. A connector as claimed in any preceding claim, having a frangible portion that can be broken to disconnect the two portions.

6. A connector as claimed in claim 5, wherein torque is transferred to the frangible portion when the two portions are rotated in one direction but not in the opposite direction.

7. A connector as claimed in claim 5 or claim 6, wherein the frangible portion comprises a shear pin located in a bush.

8. A connector as claimed in claim 7, wherein torque is applied to the bush during connection of the portions.

9. A connector as claimed in any one of claims 3 to 8, wherein the slot or groove has an axial portion and an axially inclined portion.

10. A connector as claimed in any preceding claim, having a screw thread mechanism for drawing the two portions of the connector together.

11. A connector as claimed in any preceding claim, wherein the first portion comprises a male portion that is adapted to be received within the second female portion.

12. A connector as claimed in any preceding claim, wherein the bayonet is provided on the first portion, and the receptacle is provided on the second portion.

13. A connector as claimed in any preceding claim, wherein each of the portions to be connected carries one or more fluid conducting lines that are sealingly connected to corresponding fluid conducting lines on the other portion.

14. A connector as claimed in any preceding claim, wherein the bayonet is mounted on a shaft.

15. A connector as claimed in claim 14, wherein the shaft is provided with a thread on its outer surface.

16. A connector as claimed in claim 14 or claim 15, wherein the shaft of the bayonet is received within a socket on the first portion.

17. A connector as claimed in claim 16, wherein the socket is threaded on its inner surface with a thread that co-operates with the thread on the outer surface of the shaft of the bayonet.

18. A connector as claimed in claim 17, wherein the socket is axially fixed to the first portion of the connector.

19. A connector as claimed in any preceding claim, which has indicator markings to indicate the relative positions of the two portions during make up of the connector.

20. A connector as claimed in claim 19, wherein the indicator markings indicate when the connector portions are aligned and/or fully mated.

21. A connector as claimed in claims 19 or claim 20 when dependent on claim 3, wherein the indicator markings indicate the position of the pin with respect to the slot or groove.

22. A connector as claimed in any one of claims 3 to 21 when dependent on claims 3, which has a shroud covering the pin.

23. A connector as claimed in claim 22, wherein the shroud has an interior recess.

24. A connector as claimed in claim 23, wherein the pin extends into the recess in the shroud so that the shroud rotates with the bayonet.

25. A connector as claimed in any one of claims 7 to 24 when dependent on claim 7, wherein the shroud prevents the pin from falling out of the slot or groove after the shear pin has been sheared.
